(19) United States
(12) Patent Application Publication
(10) Pub. No.: US 2025/0222689 A1
(43) Pub. Date: Jul. 10, 2025

(54) Device and Method for After-Treatment of a Printed Recording Medium

(71) Applicant: Canon Production Printing Holding B.V., Venlo (NL)

(72) Inventors: Christian Kopp, Planegg (DE); Paulo Fernando Correia Silverio, Markt Schwaben (DE); Andreas Paul, Vaterstetten (DE)

(21) Appl. No.: 19/014,590

(22) Filed: Jan. 9, 2025

(30) Foreign Application Priority Data
Jan. 10, 2024 (DE) 10 2024 100 626.9

(51) Int. Cl. B41F 23/08; B41F 19/00; B41F 23/02; B41J 11/00

(52) U.S. Cl. CPC B41F 23/08; B41F 19/001; B41F 19/002; B41F 23/02; B41J 11/002

(57) ABSTRACT

A device and a method for after-treatment of a recording medium that has been printed to is provided. A fluid is applied onto the front side of the recording medium that has been printed to at least on its front side. The printed front side is contacted by a contact transfer element. The fluid is applied and/or distributed by the contact transfer element for after-treatment of the recording medium.

### CROSS-REFERENCE TO RELATED APPLICATION

This application claims priority to German Patent Application No. 10 2024 100 626.9 filed Jan. 10, 2024, the disclosure of which is hereby incorporated by reference in its entirety.

### BACKGROUND OF THE INVENTION

### Field of the Invention

The invention relates to a device and a method for after-treatment of a printed recording medium, in which a fluid is applied onto a recording medium that has been printed to at least on its front side.

### Description of Related Art

Given printing to paper with water-based print colors and printing inks, regions with increased moisture appear due to the color separation. The surrounding non-printed regions have a moisture gradient relative to these printed regions. This moisture gradient leads to an inhomogeneous expansion of the paper (hydroexpansion), and therewith to a deformation of the paper surface. Even after the fixing, the water content in the printed regions is different than in the non-printed regions. Equilibrium is often reached only after hours, and is in particular dependent on the storage conditions, such as individual sheets in a stack or paper web on a roll.

It is known to print a fluid, such as a transparent ink or a primer, in the image-free regions, i.e. in the regions in which no visible print image should be generated. Alternatively, spraying systems are conceivable for contactless transfer of fluid onto the entire front side of the paper.

### SUMMARY OF THE INVENTION

It is the object of the invention to specify a device and a method for after-treatment of a recording medium that has been printed to, given which device and method inhomogeneous expansions are reduced or avoided.

This object is achieved by a device having the features as described herein, and by a method having the features as described herein. Advantageous developments are specified herein.

The invention proceeds from the realization that it is advantageous to apply more fluid in non-printed regions than in printed regions. This is achieved at low cost via the device having the features as described herein. In particular, no expensive hardware and only a small space requirement are necessary.

A transparent fluid, in particular water or mixtures of water with additives, serves as a fluid. A cost-effective achievement of the object that directly increases the moisture content is hereby specified. The recording medium is paper, in particular a paper web or a single sheet.

It is advantageous if the device has an inkjet printing unit that is designed to generate a print image on the front side of the recording medium, wherein the after-treatment unit is arranged downstream of the inkjet printing unit, in the transport direction of the recording medium. The application of the fluid takes place after the printing to the recording medium. The regions of the recording medium that have been printed to absorb less moisture than the non-printed regions, even given a contact of the contact transfer element with the front side of the recording medium over its entire area. This applies in particular to aqueous fluids with modified surface energy. The word “printing” can thus be understood to mean only the application of the print color or ink, or the subsequent fixing/drying and/or drying can also be additionally encompassed by the printing. An equalization of the moisture content of non-printed regions and printed regions can hereby take place in a simple manner.

It is also advantageous if the after-treatment unit is arranged between the printing unit and a fixing unit. The fixing unit serves to dry the recording medium, and is preferably arranged downstream of the after-treatment unit. The ink applied onto the front side of the recording medium to generate the print image is preferably at least dried upon contact with the contact transfer element. For this, a corresponding distance is preferably chosen between the printing unit and the after-treatment unit, or a drying unit is arranged between the printing unit and the after-treatment unit. In this arrangement, the fixing serves to approximate the equilibrium moisture.

The device can also comprise a transport unit that is designed to transport the recording medium in a transport direction. A simple after-treatment of the recording medium is hereby possible.

The contact transfer element can also comprise an absorbent wiper element or an absorbent roller or an absorbent belt, wherein the after-treatment unit comprises means that are designed to apply the fluid onto the contact transfer element and/or apply fluid onto the recording medium upstream of the contact transfer element. The application of the fluid in particular takes place by spraying the fluid onto the recording medium or onto the contact transfer element.

If the contact transfer element is a roller, this roller can be a metal roller with or without coating. The roller can also comprise a coating made from a hydrophilic material, and/or a synthetic layer of open-pored synthetic, and/or a felt layer, and/or a plurality of uniformly arranged bristles. In particular, the surface of the roller is designed as a sponge-like layer. The fluid can hereby be applied and/or distributed simply. It is thereby to be noted that the penetration behavior of the water is different at printed locations than at non-printed locations, which leads to a homogenization of the moisture.

If the same quantities were to be transferred, the remaining quantity at printed locations can be reduced by subsequent nips at rollers (or lips). The homogeneity is thereby simultaneously improved.

It is advantageous if the after-treatment unit comprises an applicator element, in particular a raster roller, to apply the fluid onto the contact transfer element. The provided fluid to be applied can hereby be dosed simply.

A control unit of the device can also be designed to control the quantity of the fluid to be applied by the after-treatment unit onto the front side of the recording medium such that, after the application of the fluid, the moisture difference between printed and non-printed regions of the front side is less than before the after-treatment unit. The printed and non-printed regions of the recording medium preferably have essentially the same moisture content after the after-treatment unit.

The or a control unit of the device can also be designed to control the quantity of fluid to be applied by the after-treatment unit onto the front side of the recording medium such that 0.5 g to 4 g, preferably 1 g to 2 g, of fluid are applied per square meter of recording medium. The quantity of fluid to be applied onto the front side of the recording medium by the after-treatment unit should be adjusted at least such that the fluid quantity is less than the fluid quantity that the recording medium can take up. The fluid quantity can thus be adapted to the printing conditions. These include influences of the specific substrate, the maximum ink quantity, the fixing conditions, but also general process conditions such as ambient climate and printing speed.

The contact transfer element can alternatively or additionally also comprise a blade and/or a wiper element. The after-treatment unit can also comprise means that are designed to apply, in particular spray, the fluid onto the recording medium upstream of the contact transfer element. The wiper element can comprise a layer of felt, bristles, fibers, and/or textile; an open-pored synthetic, in particular a sponge; and/or a hydrophilic material. The blade or the wiper element can also comprise a sealing lip. A simple distribution and/or a simple application of the fluid onto the front side of the recording medium can hereby be simply ensured.

The or a control unit of the device can also be designed to control the quantity of the fluid to be applied onto the front side of the recording medium by the after-treatment unit such that the quantity of the fluid supplied to the contact transfer element is reduced before a transport stop of the recording medium. A soaking through of the recording medium after a transport stop of said recording medium is hereby avoided.

In an exemplary embodiment, the control unit includes processing circuitry or at least one processor that is configured to perform one or more functions and/or operations of the control unit.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAN); magnetic disk storage media; optical storage media; flash memory devices; electrical, optical, acoustical or other forms of propagated signals (e.g., carrier waves, infrared signals, digital signals, etc.), and others.

Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the terms “processing circuitry” and “control unit” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAN), flash memory, a magnetic storage media, an optical disc, erasable programmable read only memory (EPROM), and programmable read only memory (PROM). The memory can be non-removable, removable, or a combination of both.

The method with the features of the parallel method claim has the same advantages as the claimed device. In particular, the method can be developed with the features of the dependent claims directed toward the device and the features of the aforementioned developments.

### BRIEF DESCRIPTION OF THE DRAWINGS

The terms FIG., FIGS., Figure, and Figures are used interchangeably in the specification to refer to the corresponding figures in the drawings.

Exemplary embodiments of the invention are explained in detail in the following using Figures. Shown therein are:

FIG. 1 a schematic depiction of an inkjet printer with at least a printing device, a fixing device, and a device for after-treatment of a printed recording medium, according to a first embodiment;

FIG. 2 a schematic depiction of the device for after-treatment of a printed recording medium according to the first embodiment according to FIG. 1;

FIG. 3 a schematic depiction of a device for after-treatment of a printed recording medium according to a second embodiment;

FIG. 4 a schematic depiction of a device for after-treatment of a printed recording medium according to a third embodiment; and

FIG. 5 a schematic depiction of a device for after-treatment of a printed recording medium according to a fourth embodiment.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

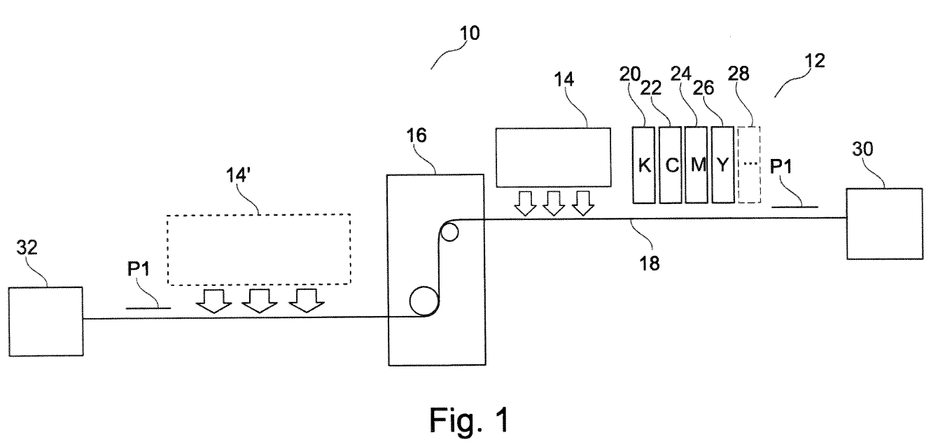

FIG. 1 shows a schematic depiction of an inkjet printer having at least an inkjet printing unit 12, a fixing unit 14, an optional additional fixing unit 14′ (shown in dashed lines), and a device 16 for after-treatment of a recording medium 18 printed to at least on its front side, according to a first embodiment. The inkjet printer 10 is in particular a high-capacity printer with print speeds of greater than 1 m/s, presently up to 3 m/s. Alternatively, or in combination, the fixing 14, 14′ can thereby be arranged before the after-treatment device in the transport direction of the medium.

The printing unit 12 serves to print to the front side of the recording medium 18 in the form of a web, executed as a paper web. The recording medium 18 is supplied to the printer in that, for example, it is taken off a roll with the aid of a take-off 30. The transport direction of the recording medium 18 through the printer 10 is indicated by the arrow P1.

In the present exemplary embodiment, the printing unit 12 comprises four print bars 20, 22, 24, 26 to generate a respective color separation in the colors Y, M, C, K on the recording medium 18 supplied to the printing unit 12. The printing unit 12 can comprise a further print bar 28 to apply a primer. This print bar 28 is then arranged upstream of the print bars 20 to 26 serving to apply the ink.

A print bar 20 to 28 of the printing unit 12 is preferably a unit that comprises at least one print head in order to print a line on the recording medium 18. Neither the print bars 20 to nor the print heads of the print bars 20 to 28 are moved upon printing the color separations. The recording medium 18 is printed across the width of the page with the aid of the print bars 20 to 28. In particular, each print bar 20 to 28 can comprise a plurality of print heads arranged one after another in two rows. The print head or print heads of the print bars 20 to 28 can be driven to print color separations printed atop one another, based on the print image data. The color separations printed atop one another then yield a print image.

The fixing unit 14 serves to generate a robust surface by drying and fixing the print image made up of ink on the recording medium 18, said print image having been generated by the printing unit 12 on said recording medium 18. After the printing, the recording medium 18 with the fixed print images is taken up again into a roll with the aid of a take-up 32. The roll with the printed recording medium 18 can then be processed further at a later point in time.

In alternative embodiments, the printing unit 12 can have more or fewer print bars 20 to 28 and/or not apply primer. The recording medium 18 that has been printed to can also be supplied directly to a unit for further processing, such as a cutting unit to cut the recording medium into individual sheets, without having been previously taken up again. Instead of the take-up 32, an additional printer may also be arranged with the aid of which the back side of the recording medium is printed to. The additional printer can have a design identical to that of the printer 10, wherein then a turning unit known per se is arranged between the two printers.

In inkjet printing, the ink that is liquid in the printing state is applied non-uniformly onto the recording medium 18 depending on the print image to be generated. This is necessary to achieve various colors, for example colors that differ locally in images. Moisture enters into the recording medium 18 via the application of liquid ink, whereby ripples appear in the recording medium 18, which ripples remain unless further measures are taken, even after the fixing of the print image on the recording medium 18 with the aid of the fixing unit 14. Moreover, the quantity of fluid/ink is distributed non-uniformly on the front side of the recording medium 18 due to regions that are printed with different intensity. The ripples in the recording medium 18 are especially pronounced in regions of the recording medium 18 that are printed to over their entire area.

Depending on the manufacturing process, the paper serving as a recording medium has a machine direction (MD), i.e. the transport direction of the paper in the paper manufacturing, and a cross direction (CD) transverse to the machine direction and thus transverse to the transport direction of the paper in the paper manufacturing. If printing to paper webs 18, the paper to be printed to can be taken off a paper roll. The machine direction is then in the take-off direction or in the transport direction P1 of the paper web 18 through the printer 10.

Due to the fluid entry into the paper of the recording medium 18, which fluid entry took place via the ink, the rippling appears primarily in the cross direction, i.e. transverse to the transport direction of the paper web 18 given printing of paper webs 18.

Ripples in the transport direction P1 can be reduced in particular such that the moisture differences between printed and non-printed regions of the printed front side of the recording medium 18 are reduced, or ideally are remedied. Only then can the paper Swell uniformly and subsequently Dry uniformly. The application of the fluid by the device 16 to after-treat the recording medium preferably takes place after the printing unit 12 and before the fixing unit 16.

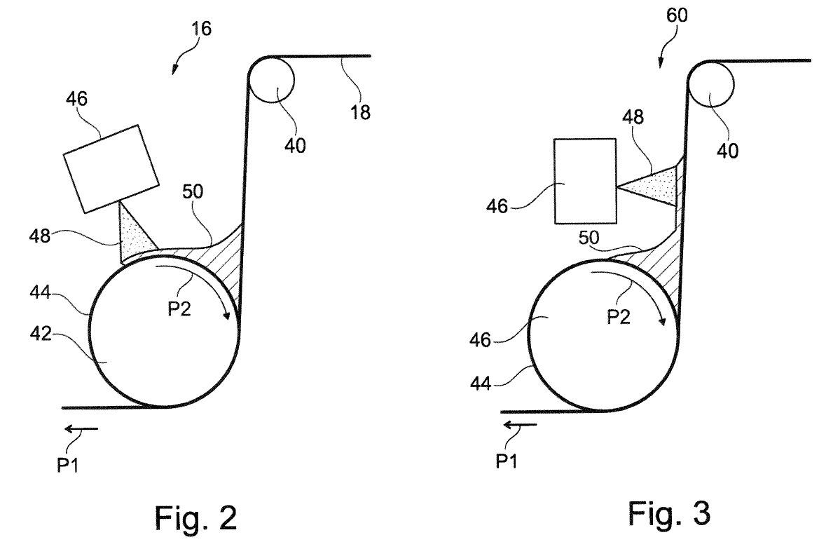

The design and the function of the device 16 is explained in further detail in the following in connection with FIG. 2.

FIG. 2 shows a schematic depiction of the device 16 for after-treatment of a recording medium 18 that has been printed to, according to the first embodiment according to FIG. 1. The device 16 comprises a first deflection roller 40 and a second deflection roller 42 that has a shell surface formed by a preferably hydrophilic layer 44. The device 16 also comprises a fluid applicator 46 that sprays onto the hydrophilic layer 44 a fluid to moisten the printed front side of the recording medium 18. Given a movement of the deflection roller 42 in the direction of arrow P2, the fluid taken up by the hydrophilic layer 44 arrives in the gap between the recording medium 18 and the roll 42. With the aid of the hydrophilic layer 44, the fluid sprayed onto the roller 42 is thus brought into contact with the printed front side of the recording medium 18 over its entire area. A fluid accumulation 50 forms before the nip, depending on the quantity of fluid sprayed onto the deflection roller. The fluid penetrates into the recording medium 18 depending on the absorbency of the surface of the recording medium 18 in the nip between the recording medium 18 and the deflection roller 42. The absorbency of the recording medium 18 is less in the printed regions than in the non-printed regions of the recording medium 18, so that the recording medium 18 absorbs less fluid in the printed regions than in the non-printed regions. The difference in the moisture between printed and non-printed regions is hereby reduced, preferably is minimized, or ideally is remedied.

FIG. 3 shows a schematic depiction of a device 60 for after-treatment of a recording medium 18 that has been printed to, according to a second embodiment. Elements having the same design or the same function have the same reference characters.

In the inkjet printer 10, the device 60 can be used instead of the device 16. The device 60 differs from the device 16 according to FIG. 2 in that the fluid applicator 46 sprays the fluid directly onto the front side of the recording medium to moisten the printed front side of said recording medium 18. Given a movement of the recording medium 18 in the direction of the arrow P1, at least a portion of the fluid arrives in the nip between the recording medium 18 and the roller 42. The fluid is at least partially taken up and/or stripped away with the aid of the hydrophilic layer 44, so that the fluid is brought into contact with the printed front side of the recording medium 18 over its entire area. A fluid accumulation 50 forms before the nip, depending on the quantity of the fluid sprayed onto the front side. The fluid penetrates into the recording medium 18 depending on the absorbency of the surface of the recording medium 18 in the nip between the recording medium 18 and the deflection roller 42. The absorbency of the recording medium 18 is less in the printed regions of the recording medium 18 than in the non-printed regions, so that the recording medium 18 takes up less fluid in the printed regions than in the non-printed regions. The difference in the moisture between printed and non-printed regions is hereby reduced, preferably is minimized, or ideally is remedied.

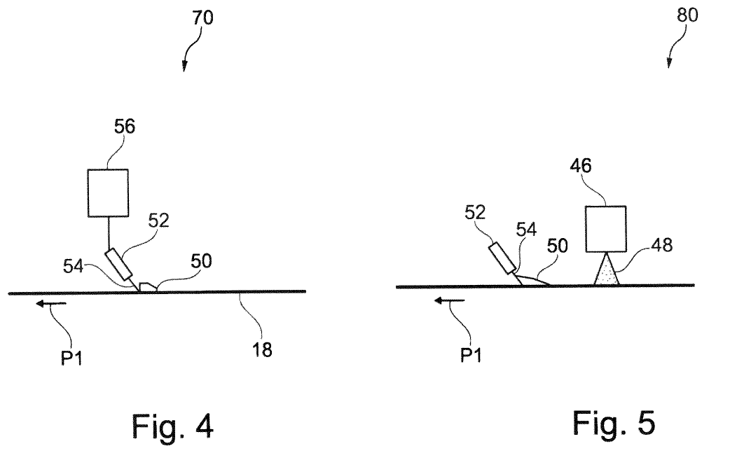

FIG. 4 shows a schematic depiction of a device 70 for after-treatment of a recording medium 18 that has been printed to, according to a third embodiment. In the inkjet printer 10, the device 70 can be used instead of the device 16. The device differs from the devices 16 and 60 in that a fluid applicator applies the fluid directly in a blade arrangement 52 to moisten the printed front side of the recording medium 18, so that a fluid accumulation 50 appears on the front side of the recording medium 18, before the blade 54 in the transport direction P1 of the recording medium. The blade arrangement 52 comprises a stripper 54, preferably a blade. In addition to the blade, the stripper can be a sponge or the like. Given a hard stripper 54—a blade—it is advantageous to omit a fibrous material to dose the fluid. The fluid is at least partially taken up by the recording medium 18, and excess fluid is stripped off with the aid of the blade 54, so that the fluid is brought into contact with the printed front side of the recording medium 18 over its entire area. The absorbency of the recording medium 18 is less in the printed regions of the recording medium 18 than in the non-printed regions, so that the recording medium 18 takes up less fluid in the printed regions than in the non-printed regions. The difference in the moisture between printed and non-printed regions is hereby reduced, preferably is minimized, or ideally is remedied. In contrast to the devices 16, 60, the device 70 has no deflection rollers, so that less required space is necessary to implement the device 70.

FIG. 5 shows a schematic depiction of a device 80 for after-treatment of a recording medium that has been printed to, according to a fourth embodiment. The device 80 differs from the device 70 in that the fluid applicator 46 sprays the fluid onto the front side of the recording medium 18 upstream of the blade 54. Given a movement of the recording medium 18 in the direction of the arrow P1, at least a portion of the fluid arrives at the blade 54, which strips off at least the fluid remaining on the front side of the recording medium 18, wherein a fluid accumulation 50 can form before the blade 54. The fluid penetrates into the recording medium 18 depending on the absorbency of the surface of said recording medium 18. The absorbency of the recording medium 18 is less in the printed regions of the recording medium 18 than in the non-printed regions, so that the recording medium 18 takes up less fluid in the printed regions than in the non-printed regions. The difference in the moisture between printed and non-printed regions is hereby reduced, preferably is minimized, or ideally is remedied.

A counter-pressure element, in particular a counter-pressure roller, can be provided in both the embodiments with the deflection roller 42 and in the embodiment with the blade 54. In particular, the contact pressure between the roller 42 and the recording medium 18 can thereby be adjusted simply, and the quantity of fluid taken up by the recording medium can thereby be controlled simply.

In the embodiments with the deflection roller 42, the fluid can also be applied and/or dosed with the aid of a raster roller or blade.

Alternatively or additionally, during printing the fluid can be applied and distributed on the front side of the recording medium 18 with the aid of a sponge having a fluid reservoir/fluid applicator. A sponge can also be a hard, porous material that is fluid-permeable. The sponge, the deflection roller 42, the blade 54 preferably respectively extend across the entire width of the recording medium 18.

On the back side of the recording medium, a contact pressure roller or another contact pressure element can be provided opposite the sponge. The after-treatment can in particular be applied after the fixing. However, it is also possible to integrate the after-treatment into the printing process.

If the front side of the recording medium 18 is first printed to with the aid of a first printing unit 12, and the back side of the recording medium 18 is subsequently printed to with the aid of a second printing unit, the described procedure can be used in order to apply a fluid after a first fixing after the first printing unit, before the recording medium 18 arrives in the second printing unit or in the second inkjet printer in order to print to and to fix the back side. Too high or too low a web tension can lead to folds, tears, breaks, or deformations of the paper. It is therefore important to maintain the optimal web tension during the entire process. An after-treatment of the back side of the recording medium 18 can subsequently be implemented in the same manner. This enables a higher and more even moisture content before the back side printing. The after-treatment before the second printing unit can also contribute to conditioning the nip and preventing a clogging of the nozzles of the print heads of the print bars 20 to 28 of the second printing unit. It is advantageous to fix first, then to correctly apply the fluid onto the relevant side. Alternatively, the fluid can also be applied to both sides only after printing to both sides.

The color layer applied onto the recording medium 18 via the printed ink requires only a slight solidification at the moment at which the fluid is applied. No additional step is thus required after or before the fixing. In particular, a higher moisture content of the recording medium 18 also supports a film formation during the fixing and/or a moisture-compensating drying.

As an alternative or in addition to the blade 54, the deflection roller 42, and/or the sponge, the fluid remaining on the front side of the recording medium 18 can also be distributed with the aid of an air blade or a wiper made of a textile or felt, in order to optimize the results.

The proposed after-treatment is much more cost-effective than printing a colorless fluid with the aid of an additional print bar.

The fluid applicators 46, 56 can simply apply a uniform fluid quantity onto the entire front side of the recording medium 18.

### REFERENCE LIST

inkjet printer
printing unit
fixing unit
16, 60, 70, 80 device
recording medium
to 28 print bar
take-off
32 take-up
40, 42 deflection roller
hydrophilic layer
46, 56 fluid applicator
spray cone
50 excess fluid
blade arrangement
blade
P1, P2 direction

1. A device for after-treatment of a recording medium that has been printed to, the device comprising:
an after-treatment unit for applying a fluid onto a front side of the at least one recording medium that has been printed to on the front side,
wherein the after-treatment unit comprises at least one contact transfer element that contacts at least an entire printable region of the printed front side of the recording medium and applies and/or distributes a fluid for after-treatment of the recording medium,
wherein the contact transfer element comprises one of an absorbent wiper element, an absorbent roller, an absorbent belt, and/or a plurality of uniformly arranged bristles, wherein the after-treatment unit comprises at least one fluid applicator configured to apply the fluid onto the contact transfer element and/or to apply the fluid onto the recording medium upstream of the contact transfer element, such that a fluid accumulation appears before the nip between the recording medium and the contact transfer element.

2. The device according to claim 1, further comprising an inkjet printing unit that is configured to generate a print image on the front side of the recording medium, wherein the after-treatment unit is arranged downstream of the inkjet printing unit in the transport direction of the recording medium.

3. The device according to claim 2, wherein the after-treatment unit after the printing unit is arranged after a fixing unit.

4. The device according to claim 1, wherein the device comprises a transport unit that is designed to transport the recording medium in a transport direction.

5. The device according to claim 1, wherein the roller is a metal roller with or without coating, wherein the roller preferably comprises a coating made of a hydrophilic material, and/or a synthetic layer of open-pored synthetic material, and/or a felt layer, and/or a plurality of uniformly arranged bristles.

6. The device according to claim 5, wherein the roller comprises a coating made of a hydrophilic material, and/or a synthetic layer of open-pored synthetic material, and/or a felt layer.

7. The device according to claim 1, wherein the after-treatment unit comprises an applicator element to apply the fluid onto the contact transfer element.

8. The device according to claim 7, wherein the applicator element is a raster roller.

9. The device according to claim 1, further comprising a control unit configured to control the quantity of the fluid to be applied by the after-treatment unit onto the front side of the recording medium such that, after the application of the fluid, a moisture difference between printed and non-printed regions of the front side of the recording medium is less than before the after-treatment unit.

10. The device according to claim 1, further comprising a control unit configured to control the quantity of fluid to be applied by the after-treatment unit onto the front side of the recording medium such that 0.5 g to 4 g of fluid are applied per square meter of recording medium.

11. The device according to claim 1, further comprising a control unit configured to control the quantity of fluid to be applied by the after-treatment unit onto the front side of the recording medium such that 1 g to 2 g of fluid are applied per square meter of recording medium.

12. The device according to claim 1, wherein the contact transfer element comprises a blade and/or a wiper element, wherein the fluid applicator sprays the fluid onto the recording medium upstream of the contact transfer element.

13. The device according to claim 1, further comprising a control unit configured to control the quantity of fluid to be applied by the after-treatment unit onto the front side of the recording medium such that the quantity of fluid supplied to the contact transfer element is reduced before a stop of the recording medium.
